(19) United States
(12) Patent Application Publication
(10) Pub. No.: US 2026/0087690 A1
(43) Pub. Date: Mar. 26, 2026

(54) RENDERING METHOD AND APPARATUS, DEVICE, COMPUTER READABLE STORAGE MEDIUM AND PRODUCT

(71) Applicant: Beijing Zitiao Network Technology Co., Ltd., Beijing (CN)

(72) Inventor: Yu LI, Beijing (CN)

(21) Appl. No.: 19/337,506

(22) Filed: Sep. 23, 2025

(30) Foreign Application Priority Data
Sep. 24, 2024 (CN) 202411338137.8

(51) Int. Cl. G06T 11/00; G06F 9/451; G06T 1/20; G06T 11/60

(52) U.S. Cl. CPC G06T 11/10; G06F 9/452; G06T 1/20; G06T 11/60; G06T 2200/24

(57) ABSTRACT

Embodiments of the present disclosure relates to a rendering method and apparatus, a device, a computer readable storage medium and a product. The method includes: obtaining a first context associated with a plurality of preset windows to be rendered, wherein the first context is used for managing a rendering resource and an interface status associated with each preset window; performing, based on the first context, off-screen content rendering on an extended surface associated with each preset window, to obtain a rendered content corresponding to each preset window; and rendering, based on a second context associated with each preset window, the rendered content corresponding to the preset window onto the preset window, where the second context is used for managing the extended surface corresponding to each preset window, and the first context shares a rendering resource with the second context associated with the preset window.

### CROSS-REFERENCE TO RELATED APPLICATION(S)

This application claims priority to Chinese Application No. 202411338137.8 filed Sep. 24, 2024, the disclosure of which is incorporated herein by reference in its entirety.

### FIELD

The present disclosure relates to the field of computer technology, and more specifically, to a rendering method and apparatus, a device, a computer readable storage medium and a product.

### BACKGROUND

An Open Graphics Library (abbreviated as Open GL) is a cross-language, cross-platform Application Programming Interface (API) for rendering 2D and 3D vector graphics. In the related technology, the Open GL is typically used for window rendering. An Open Graphics Library Context (abbreviated as OpenGL Context) is a core concept in OpenGL programming, which contains all resources required for window rendering, for example, colors, buffer zones, texture objects, shader statuses, and the like.

### SUMMARY

Embodiments of the present disclosure provide a rendering method and apparatus, a device, a computer readable storage medium and a product.

In a first aspect, the embodiments of the present disclosure provide a rendering method, comprising:
obtaining a first context associated with a plurality of preset windows to be rendered, wherein the first context is used for managing a rendering resource and an interface status associated with each preset window;
performing, based on the first context, off-screen content rendering on an extended surface associated with each preset window, to obtain a rendered content corresponding to each preset window; and
rendering, based on a second context associated with each preset window, the rendered content corresponding to the preset window onto the preset window, wherein the second context is used for managing the extended surface corresponding to each preset window, and the first context shares a rendering resource with the second context associated with the preset window.

In a second aspect, the embodiments of the present disclosure provide a rendering apparatus, comprising:
an obtaining module for obtaining a first context associated with a plurality of preset windows to be rendered, wherein the first context is used for managing a rendering resource and an interface status associated with each preset window;
a rendering module for performing, based on the first context, off-screen content rendering on an extended surface associated with each preset window, to obtain a rendered content corresponding to each preset window; and
a processing module for rendering, based on a second context associated with each preset window, the rendered content corresponding to the preset window onto the preset window, wherein the second context is used for managing the extended surface corresponding to each preset window, and the first context shares a rendering resource with the second context associated with the preset window.

In a third aspect, the embodiments of the present disclosure provide an electronic device, comprising: a processor and a memory, wherein:
the memory stores therein computer executable instructions;
the computer executable instructions stored in the memory, when executed by the processor, cause the processor to perform the rendering method in the first aspect and various possible rendering methods designed according to the first aspect.

In a fourth aspect, the embodiments of the present disclosure provide a computer readable storage medium, wherein the computer readable storage medium stores therein computer executable instructions that, when executed by a processor, implement the rendering method in the first aspect and various possible rendering methods designed according to the first aspect.

In a fifth aspect, the embodiments of the present disclosure provide a computer program product comprising a computer program, wherein the computer program, when executed by a processor, implements the rendering method in the first aspect and various possible rendering methods designed according to the first aspect.

According to the rendering method and apparatus, the device, the computer readable storage medium and the product provided by the embodiments, by presetting a first context for managing rendering resources and interface statuses associated with a plurality of preset windows to be rendered, and presetting an extended surface for each preset window, an off-screen content rendering operation can be performed on the extended surface associated with each preset window to obtain the rendered content corresponding to the preset window, based on the first context; and then, the rendered content corresponding to the preset window can be rendered onto the preset window, based on an independent second context associated with each preset window, to obtain a rendering result.

### BRIEF DESCRIPTION OF THE DRAWINGS

In order to make clearer the technical solution according to the embodiments of the present disclosure or the prior art, brief introduction of the drawings required in the embodiments or the prior art will be provided below. Apparently, the drawings depicted below only relate to some embodiments of the present disclosure, and those of ordinary skill in the art could derive other drawings on the basis of those drawings, without doing creative work.

FIG. 1 illustrates a schematic diagram of an existing effect rendering process provided by an embodiment of the present disclosure;

FIG. 2 illustrates a schematic flowchart of a rendering method provided by an embodiment of the present disclosure;

FIG. 3 illustrates a schematic diagram of a scene of a rendering method provided by an embodiment of the present disclosure;

FIG. 4 illustrates a schematic flowchart of a rendering method provided by a further embodiment of the present disclosure;

FIG. 5 illustrates a schematic flowchart of a rendering method provided by a still further embodiment of the present disclosure;

FIG. 6 illustrates a schematic diagram of a structure of a rendering apparatus provided by an embodiment of the present disclosure; and

FIG. 7 illustrates a schematic diagram of a structure of an electronic device provided by an embodiment of the present disclosure.

### DETAILED DESCRIPTION OF EMBODIMENTS

In order to make the above objective, features and advantages of the present disclosure much clearer, reference below will be made to the drawings to provide clear and complete description of the technical solution according to the present disclosure. Obviously, the embodiments of the present disclosure are only a part of the embodiments of the present disclosure, not all of them. On the basis of the embodiments described herein, those of ordinary skill in the art could derive all the other embodiments, without doing creative work, which should all fall into the scope of protection of the present disclosure.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

### Definition of Terms

Open Graphics Library (abbreviated as Open GL): a cross-language, cross-platform Application Programming Interface (API) for rendering 2D and 3D vector graphics, which is composed of about 350 different function calls, to render a complex three-dimensional scene using simple graphic bits.

Open Graphics Library Context (abbreviated as OpenGL Context): a core concept in OpenGL programming, which represents all states of an OpenGL state machine. When graphics rendering is performed using the OpenGL, all the OpenGL function calls are performed for a specific context. The context contains all the state information required for rendering, for example, colors, buffer zones, texture objects, shader statuses, and the like.

Extended surface (Open GL surface): an Open GL object for off-screen rendering, which can be rendered in the backend and stored onto the GPU, but not directly rendered to a window.

In the related technology, when a multi-window rendering operation is performed, an independent context is set for each window, to prevent mutual interference of rendering operations for different windows. In order to save the memory while improving the performance, each window has a context shared with other windows, where the shared context contains a resource content of display elements existing in a plurality of windows. In this way, the resource content in the shared context can be shared among different OpenGL windows or controls, without being created repeatedly. However, when window rendering is performed using the method, there is often the case that some resources cannot be supported, resulting in a failure at accurately performing window rendering. In order to solve the technical problem that some resources cannot be shared in the existing window sharing method, the present disclosure provide a rendering method and apparatus, a device, a computer readable storage medium and a product.

It is worth noting that the rendering method and apparatus, the device, the computer readable storage medium and the product provided by the present disclosure can be applied to any one of Open GL-based window rendering scenarios.

In the related technology, when a multi-window rendering operation is performed, an independent context is set for each window, to prevent mutual interference of rendering operations for different windows. Moreover, each window has a context shared with other windows. As a result of sharing the context, the resources in the shared context can be shared among different windows, without being created repeatedly, so as to save the memory while improving the performance.

However, when the above-mentioned method is used for sharing a context, some resources do not support sharing, for example, a Vertex Array Object (abbreviated as VAO), a Framebuffer Object (abbreviated as FBO), and the like.

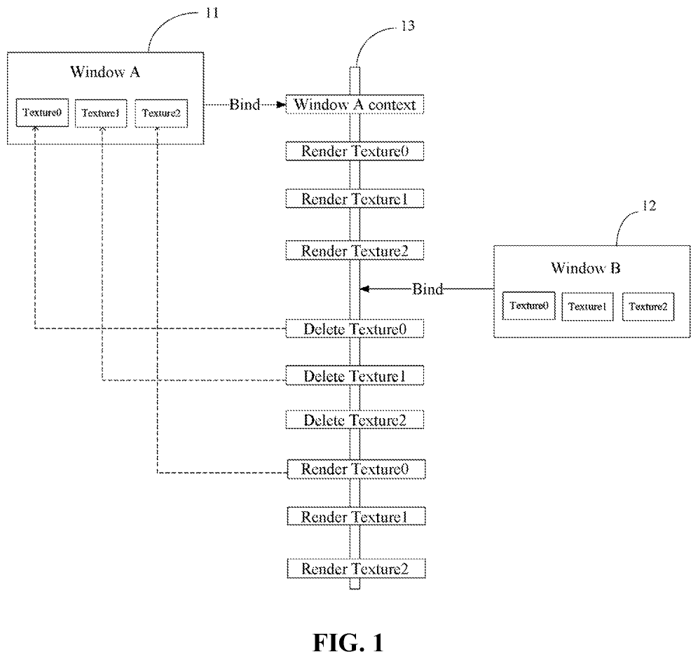

In addition, when effect rendering is performed, an effect engine is generally a preset virtual machine. The preset virtual machine is provided therein with a garbage collection mechanism. FIG. 1 illustrates a schematic diagram of an existing effect rendering process provided by an embodiment of the present disclosure. As shown therein, a window A11 and a window B12 are to be rendered, which respectively correspond to an independent context, and a rendering operation for a window A and a window B can be implemented through a preset main thread 13. The window A includes three textures to be rendered, and the window B also includes three textures to be rendered. In the rendering process, the main thread 13 is bound to the context of the window A11 to implement the rendering operation on the window A11, and the three textures associated with the window A11 are respectively named as texture0, texture1, and texture2. Having completed the rendering operation on the window A11, the main thread 13 can be further bound to the context of the window B12 to implement the rendering operation on the window B12, and the three textures associated with the window B12 are respectively named as texture0, texture1, and texture2. At the end of the rendering operation for the window A11, the garbage collection mechanism will not immediately collect the textures associated with the window A11. Only when a trigger condition is met, the garbage collection mechanism will perform the garbage collection operation, where the trigger condition may be that the memory is idle or reaches a preset threshold. For example, if the trigger condition is met when the window B12 is being rendered, the garbage collection mechanism will collect the textures associated with the rendered window A11. However, since the textures associated with the window A11 and those associated with the window B12 have the same names, the garbage collection mechanism may mistakenly collect the textures associated with the window B, leading to a failure at rendering the window B12.

In the process of solving the problem, through research, the inventor has found that, to avoid the problem that some resources cannot be shared caused by sharing the context, a first context containing rendering resources associated with a plurality of preset windows to be rendered can be preset, and an independent second context only containing window information can be set for each preset window. Based on the first context, a content rendering operation can be performed on an extended surface associated with each preset window, to obtain a rendering target corresponding to each preset window. Subsequently, the rendering target is rendered to each preset window based on the second context. Since resource contents associated with the plurality of preset windows are all stored in the first context, the case that some resources do not support sharing due to the context sharing operation will not occur any longer.

Further, as the rendering resources associated with the plurality of preset windows to be rendered are all contained in the first context and each rendering resource in the first context has a different name, the garbage collection mechanism is prevented from mistakenly collecting the resource currently used for rendering when the main thread is performing the rendering operation based on the first context. In addition, when an on-screen operation is performed on the rendering target based on the second context, due to a fast on-screen speed, the garbage collection mechanism can be controlled not to perform the collection operation. Therefore, mistaken collection will not occur in the on-screen stage.

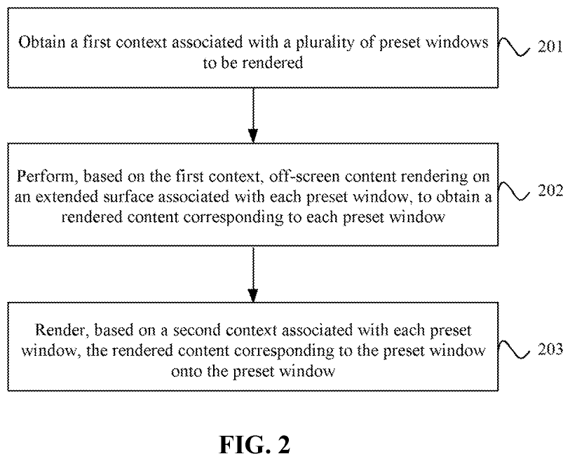

FIG. 2 illustrates a schematic flowchart of a rendering method provided by an embodiment of the present disclosure. As shown therein, the method includes:

Step 201: a first context associated with a plurality of preset windows to be rendered is obtained, where the first context is used for managing a rendering resource and an interface status associated with each preset window.

The performer in the embodiment is a rendering apparatus. The rendering apparatus may be coupled into the server or the virtual machine, which is not limited herein.

In the implementation, in various scenarios of, for example, effect production, game interface rendering, web page rendering, and the like, a plurality of windows are displayed at the same time. In order to enable normal display of those windows, a rendering operation can be performed on the windows using the Open GL.

In the related technology, when the window rendering operation is performed based on the Open GL, an independent context is set for each window, and each window has a context shared with other windows, such that the same resources can be shared among a plurality of windows. However, if the above method is used to share a context, there remains some resources that cannot be shared, for example, a Vertex Array Object (abbreviated as VAO), a Framebuffer Object (abbreviated as FBO), and the like.

In the scenario of rendering a plurality of windows, in order to solve the problem that some resources cannot be shared in the process of rendering the plurality of windows, and to save the memory while improving the performance, a first context can be pre-created based on rendering resources associated with a plurality of preset windows to be rendered currently. The first context is used for managing a rendering resource and an interface status associated with each preset window, where the rendering resource includes, but is not limited to, images to be rendered in the preset window, textures, and the like, and the interface status includes, but is not limited to, a rendering buffer interface, a view setting interface, a data buffering-related interface, a shader status interface, and the like.

Optionally, the first context can be created upon activation of the target application, and be kept active throughout the life cycle of the target application. Therefore, when a rendering operation is performed on the plurality of preset windows, the first context can be obtained.

In step 202: off-screen content rendering is performed on an extended page associated with each preset window, based on the first context, to obtain a rendered content corresponding to each preset window.

In the implementation, an extended surface associated with each preset window can be pre-created for the preset window, and an off-screen content rendering operation can be performed on the extended surface based on the first context, to obtain a rendered content corresponding to each preset window.

In step 203: the rendered content corresponding to the preset window is rendered onto the preset window, based on a second context associated with each preset window, where the second context is used for managing the extended page corresponding to each preset window, and the first context shares a rendering resource with the second context associated with the preset window.

In the implementation, an independent second context can be set for each preset window. The second context may include only identifier information of the preset window, to manage the extended surface corresponding to the preset window. After obtaining the rendered content from the off-screen rendering operation, the rendered content can be rendered to the preset window based on the second context, to achieve on-screen display of the rendered content.

Since the first context is preset and the rendered content is rendered to the extended surface based on the first context, it is only required to perform an on-screen operation for the second context, without the necessity for sharing resources among the respective second contexts. In this way, the present disclosure can effectively solve the existing problem that some resources cannot be shared due to the context sharing operation.

Further, since it is required to perform the on-screen operation for the second context according to the result of rendering based on the first context, which indicates that the resources created by the first context should be accessible to the respective second contexts, resource sharing is required between the first context and the respective second contexts.

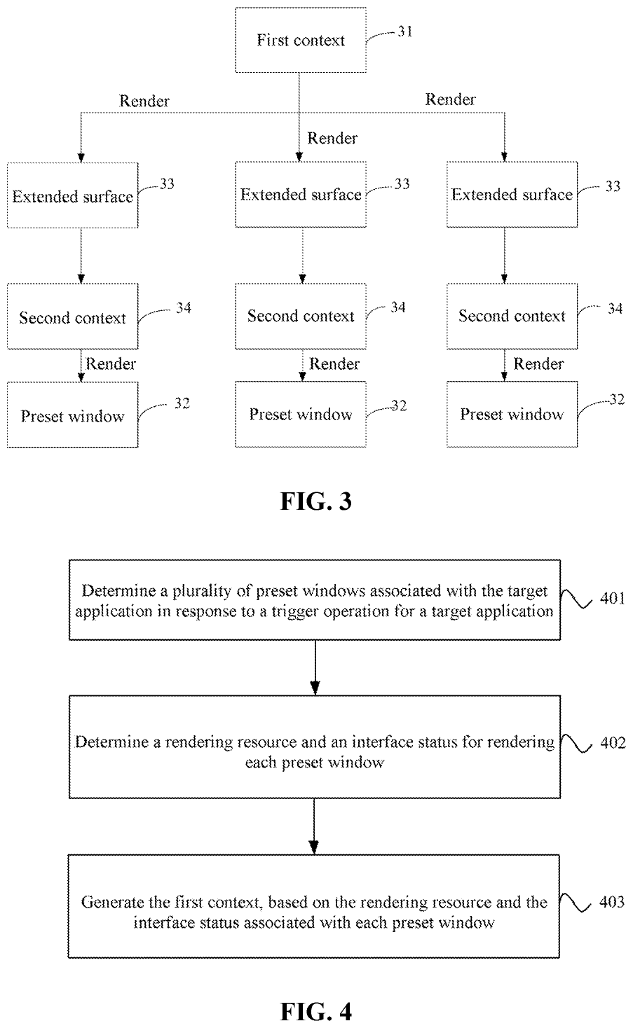

FIG. 3 illustrates a schematic diagram of a scene of a rendering method provided by an embodiment of the present disclosure. As shown therein, a first context 31 can be preset, which includes rendering resources associated with a plurality of preset windows to be rendered. Then, a content rendering operation can be performed on an extended surface 33 associated with the plurality of preset windows 32, based on the first context 31. In addition, an independent second context 34 is set for each preset window 32. After the rendering operation has been completed on the extended surface 33, the second context 34 corresponding to each preset window 32 can be rendered to the preset window 32.

According to the rendering method provided by the embodiment, by presetting a first context containing rendering resources associated with a plurality of preset windows to be rendered, and presetting an extended surface for each preset window, an off-screen content rendering operation can be performed on the extended surface associated with each preset window, based on the first context, to obtain a rendered content corresponding to each preset window; and then, the rendered content corresponding to the preset window can be rendered onto the preset window, based on an independent second context associated with each preset window, to obtain a rendering result. Since the resource contents associated with a plurality of preset windows are all stored in the first context, it is impossible that some resources cannot be supported due to the context sharing operation. In addition, as the rendering operations are all performed in the first context, the present disclosure can effectively implement resource sharing, and is compatible with various types of resource contents and more efficient in completing the rendering process and utilizing the resources.

Optionally, on the basis of any of the embodiments described above, step 202 includes:
an extended surface associated with the preset window is created for each preset window; and
an off-screen rendering operation on the extended surface is performed, based on the rendering resource and the interface status managed by the first context, to obtain the rendered content.

In the embodiment, for each preset window, an extended surface associated with the preset window can be pre-created, and then, the off-screen content rendering operation is performed on the extended surface, based on the rendering resource in the first context, to obtain the rendered content.

The rendering resource in the first context may have a preset mapping relationship with the extended surface. For example, the preset window A corresponds to the rendering resource 1, the rendering resource 2 and the rendering resource 3. Therefore, after obtaining the first context, the rendering resource corresponding to each extended surface can be determined accurately, and then, the off-screen rendering operation can be performed accurately on the extended surface.

Optionally, the rendered content corresponding to each preset window may act as the rendering target, and subsequently, the rendering target can be rendered to the preset window based on the second context.

According to the rendering method provided by the embodiment, by creating an extended surface associated with a preset window, the off-line rendering operation can be performed on the extended surface based on the first context, and the rendered content can be rendered to each preset window based on a second context corresponding to the preset window. In this way, the present disclosure can effectively avoid the case that some resources cannot be supported due to the context sharing operation, and improve the content rendering efficiency.

FIG. 4 illustrates a schematic flowchart of a rendering method provided by a further embodiment of the present disclosure. On the basis of any of the embodiments described above, as shown in FIG. 4, step 201 includes:

step 401: a plurality of preset windows associated with the target application are determined, in response to a trigger operation for a target application, where the rendering resource and the preset window have a preset mapping relationship therebetween.

step 402: a rendering resource and an interface status are determined for rendering each preset window.

step 403: the first context is generated, based on the rendering resource and the interface status associated with each preset window.

In this embodiment, the first context can be created upon activation of a target application and remains active throughout the life cycle of the target application.

Therefore, in response to a preset trigger operation for the target application, rendering resources and interface statuses for the plurality of preset windows associated with the target application are obtained. Wherein, the preset trigger operation includes, but is not limited to, an activation operation for the target application, a display operation for a plurality of pages in the target application, a specific content rendering operation, and the like. The plurality of preset windows associated with the target application may be all windows associated with the target application, a plurality of windows to be displayed in response to a current preset trigger operation performed by the user, or the like, which is not limited herein.

In order to accurately implement the rendering operation for the preset window, the rendering resource and the preset window have a preset mapping relationship. The preset window corresponds to the associated extended surface, and the rendering resource and the interface status associated with the preset window therefore have a corresponding mapping relationship with the extended surface.

Further, after the rendering resources and the interface statuses for the plurality of preset windows associated with the target application have been obtained respectively, a first context can be generated based on the rendering resources and the interface statuses for the plurality of preset windows associated with the target application. The first context is controlled to keep active throughout the life cycle of the target application, and the first context therefore can be called at any time to implement the rendering operation of the preset window.

In the rendering method provided by the embodiment, a first context is created upon activation of a target application and remains active throughout the life cycle of the target application, and thus, a content rendering operation can be implemented accurately based on the first context.

On the basis of any of the embodiments described above, step 402 includes:
rendering sequence numbers for the rendering resources associated with the plurality of preset windows are set, based on a preset condition, where different rendering resources have different rendering sequence numbers.

In the embodiment, due to the garbage collection mechanism, the created OpenGL resources are destroyed with a delay, rather than immediately. Accordingly, the resources created at the window A Context may be destroyed when the window B Context is being rendered. However, this may lead to errors in resource destruction.

In order to solve the above technical problem, after the first context has been created based on the rendering resources associated with the plurality of preset windows, rendering sequence numbers can be set respectively for rendering resources associated with a plurality of preset windows, based on a preset condition, where different rendering resources have different rendering sequence numbers. Since the rendering sequence numbers are different, the garbage collection mechanism is prevented from causing incorrect destruction of resources due to duplicate naming.

Optionally, the preset condition may be setting rendering sequence numbers according to a rendering order of the rendering sources, or may be setting a rendering requirement based on a rendering priority of a rendering resource, or the like, which is not limited herein.

On the basis of any of the embodiments described above, step 202 includes:
an off-screen content rendering operation is performed sequentially according to the rendering sequence number, on the extended surface associated with each preset window, based on the rendering resource, to obtain the rendered content corresponding to each preset window.

In the embodiment, according to the rendering sequence number, an off-screen content rendering operation can be performed on the extended surface associated with each preset window using a preset thread, based on the rendering resource, to obtain the rendered content corresponding to each preset window. When the content rendering operation is performed using a single preset thread, the garbage collection mechanism is not triggered in the rendering process, preventing incorrect destruction of resources.

In the rendering method provided by the embodiment, different rendering sequence numbers are set for a plurality of rendering resources for rendering a plurality of preset windows, and an off-screen content rendering operation is performed based on the rendering sequence number, thereby preventing the garbage collection mechanism from causing incorrect collection due to duplicate naming, and ensuring the accuracy of window rendering.

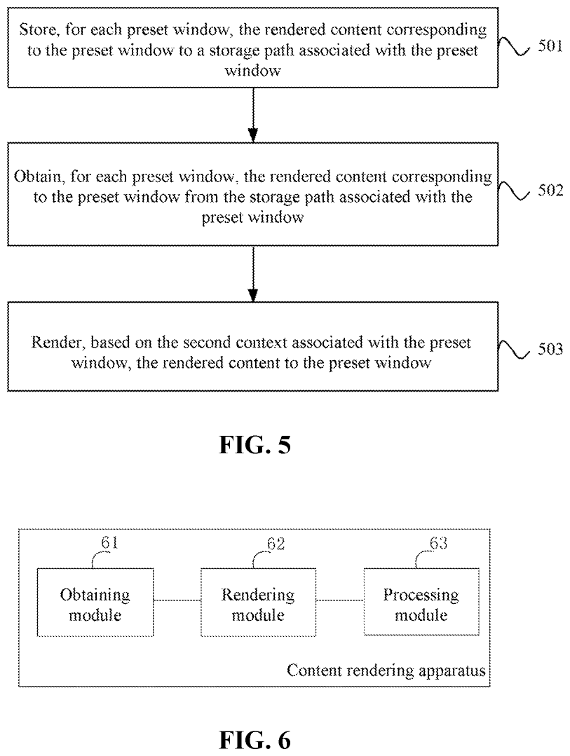

FIG. 5 illustrates a schematic flowchart of a rendering method provided by a further embodiment of the present disclosure. On the basis of any of the embodiments described above, as shown therein, after step 202, the method further includes:

Step 501: for each preset window, the rendered content corresponding to the preset window is stored to a storage path associated with the preset window.

Step 203 includes:

Step 502: for each preset window, the rendered content corresponding to the preset window is obtained from the storage path associated with the preset window.

Step 503: the rendered content is rendered to the preset window, based on the second context associated with the preset window.

In the embodiment, after performing the off-screen content rendering on the extended surface to obtain the rendered content, the rendered content can be cached in the GPU, and an on-screen operation, if required, is performed based on the second context after obtaining the rendered content from the GPU.

Alternatively, for each preset window, the rendered content corresponding to the preset window is stored to a storage path associated with the preset window, where the storage path may be a preset storage path in the GPU. If an on-screen operation is to be performed, the rendered content corresponding to each preset window is obtained from the storage path associated with the preset window. Based on the second context associated with the preset window, the rendered content is rendered to the preset window.

In the rendering method provided by the embodiment, after completing the off-screen rendering, the rendered content is stored to a preset storage path; if an on-screen operation is required, the rendered content is obtained from the storage path and then rendered based on the second context. In this way, all the content rendering operations are performed based on the first context, thereby effectively realizing the sharing of the GPU resources such as textures, shaders, and the like. In addition, since all the rendering operations are completed in the first context, the method is more efficient in completing the rendering process and utilizing resources.

On the basis of any of the embodiments described above, step 203 includes:

For each preset window, if rendering the extended surface associated with the preset window has been completed, the rendered content corresponding to the preset window is rendered to the preset window based on the second context associated with the preset window, to obtain a rendering result.

In the embodiments, in the scenario of rendering a plurality of windows, in order to ensure the accurate display of the preset window and avoid a loss of display elements within the preset window, a GPU synchronization method can be used to ensure that the on-screen operation is performed after the rendering has been completed.

Optionally, for each preset window, after determining that the extended surface associated with the preset window has been rendered, the rendered content corresponding to the preset window is rendered to the preset window based on the second context associated with the preset window, to obtain a rendering result.

As an implementation, using gIFenceSync and glClienetWaitSyn of OpenGL, a synchronization point can be created on the GPU, to ensure that different rendering operations can be completed at the correct time.

In the rendering method provided by the embodiment, by performing the on-screen operation after determining that the extended surface associated with the preset window has been rendered, it is ensured that the preset windows in the target application can be displayed normally in a multi-window rendering environment.

On the basis of any of the embodiments described above, a preset effect engine runs on the first context, and the method further includes:
controlling the effect engine to perform, based on the first context, a content rendering operation on the plurality of preset windows.

In the embodiment, the target application may be an application for effects rendering.

Correspondingly, a preset effect engine runs on the first context. The effect engine can flexibly perform rendering operations for different preset windows based on the first context. Therefore, rendering visual effects can be generated on any window based on the first context. After the effects rendering operation has been completed, the rendered effect content can be rendered to the preset window based on the second context associated with the preset window, to achieve accurate display of the effects.

In the rendering method provided by the embodiment, by running a preset effect engine on the first context, the effect engine can implement visual effect processing on any window based on the first context, improving the flexibility of the effects rendering.

FIG. 6 illustrates a schematic diagram of a structure of a rendering apparatus provided by an embodiment of the present disclosure. As shown therein, the apparatus includes: an obtaining module 61, a rendering module 62 and a processing module 63. Wherein, the obtaining module 61 is used for obtaining a first context associated with a plurality of preset windows to be rendered, wherein the first context is used for managing a rendering resource and an interface status associated with each preset window. The rendering module 62 is used for performing, based on the first context, off-screen content rendering on an extended surface associated with each preset window, to obtain a rendered content corresponding to each preset window. The processing module 63 is used for rendering, based on a second context associated with each preset window, the rendered content corresponding to the preset window onto the preset window, where the second context is used for managing the extended surface corresponding to each preset window, and the first context shares a rendering resource with the second context associated with the preset window.

On the basis of any of the embodiments described above, the rendering module is used for: creating, for each preset window, an extended surface associated with the preset window; and performing an off-screen rendering operation on the extended surface, based on the rendering resource and the interface status managed by the first context, to obtain the rendered content.

On the basis of any of the embodiments described above, the obtaining module is used for: in response to a trigger operation for a target application, determining a plurality of preset windows associated with the target application, wherein the rendering resource and the preset window have a preset mapping relationship therebetween; determining a rendering resource and an interface status for rendering each preset window; and generating the first context, based on the rendering resource and the interface status associated with each preset window.

On the basis of any of the embodiments described above, the obtaining module is used for: setting, based on a preset condition, rendering sequence numbers for the rendering resources associated with the plurality of preset windows, where different rendering resources have different rendering sequence numbers.

On the basis of any of the embodiments described above, the rendering module is used for: performing sequentially, based on the rendering resource, an off-screen content rendering operation on the extended surface associated with each preset window, according to the rendering sequence number, to obtain the rendered content corresponding to each preset window.

On the basis of any of the embodiments described above, the apparatus further includes: a storage module for: storing, for each preset window, the rendered content corresponding to the preset window to a storage path associated with the preset window. The processing module is used for: obtaining, for each preset window, the rendered content corresponding to the preset window from the storage path associated with the preset window; and rendering, based on the second context associated with the preset window, the rendered content to the preset window.

On the basis of any of the embodiments described above, the processing module is used for: for each preset window, in response to the extended surface associated with the preset window having been rendered, rendering, based on the second context associated with each preset window, the rendered content corresponding to the preset window onto the preset window, to obtain a rendering result.

On the basis of any of the embodiments described above, a preset effect engine runs on the first context, and the method further includes: controlling the effect engine to perform, based on the first context, a content rendering operation on the plurality of preset windows.

The device provided by the embodiments can perform the method according to any one of the embodiments described above. The implementation principle and advantageous effects are similar to those of the method embodiments, details of which are omitted herein.

In order to implement the embodiments described above, the embodiments of the present disclosure further provide a computer readable storage medium, where the computer readable storage medium stores therein computer executable instructions that, when executed by a processor, implement the rendering method according to any of the embodiments described above.

In order to implement the embodiments described above, the embodiments of the present disclosure further provide a computer program product including a computer program, where the computer program, when executed by a processor, implements the rendering method according to any of the embodiments described above.

In order to implement the embodiments described above, the embodiments of the present disclosure further provide an electronic device, including: a processor and a memory, where:
the memory stores therein computer executable instructions; wherein
the computer executable instructions stored in the memory, when executed by the processor, cause the processor to perform the rendering method according to any of the embodiments described above.

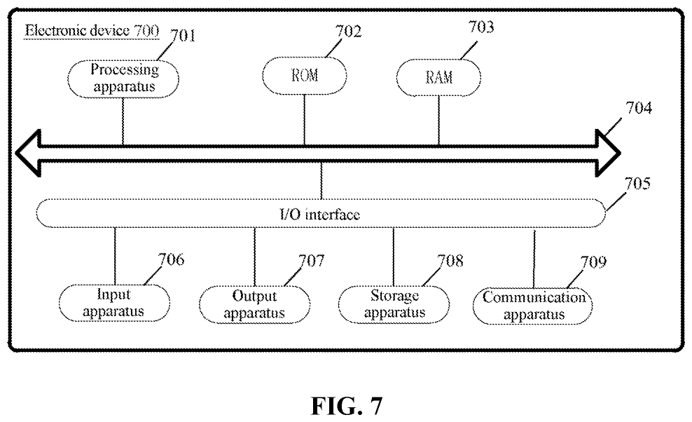

FIG. 7 illustrates a schematic diagram of an electronic device provided by an embodiment of the present disclosure, where the electronic device 700 may be a terminal device or a server. The terminal device may include, but is not limited to, a mobile terminal such as a mobile phone, a laptop computer, a digital broadcast receiver, a Personal Digital Assistant (PDA), a tablet computer (PAD), a Portable Multimedia Player (PMP), an on-vehicle terminal (e.g. an on-vehicle navigation terminal), or the like, or a fixed terminal such as a digital TV, a desktop computer, or the like. The electronic device as shown in FIG. 7 is only an example, without suggesting any limitation to the functions and the application range of the embodiments of the present disclosure.

As shown therein, the electronic device 700 may include a processing apparatus (e.g. a central processing unit, a graphics processing unit or the like) 701, which can execute various acts and processing based on programs stored in a Read-Only Memory (ROM) 702 or a program loaded from a storage apparatus 708 to a Random Access Memory (RAM) 703. RAM 703 stores therein various programs and data required for operations of the electronic device 700. The processing apparatus 701, the ROM 702, and the RAM 703 are connected to one another via a bus 704. An input/output (I/O) interface 705 is also connected to the bus 704.

Typically, the following units may be connected to the I/O interface 705: an input apparatus 706 including, for example, a touchscreen, a touch pad, a keyboard, a mouse, a camera, a microphone, an accelerometer, a gyroscope, and the like; an output apparatus 707 including, for example, a Liquid Crystal Display (LCD), a loudspeaker, a vibrator, and the like; a storage apparatus 708 including, for example, a tape, a hard drive, and the like; and a communication apparatus 709. The communication apparatus 709 can allow wireless or wired communication of the electronic device 700 with other devices to exchange data. Although FIG. 7 shows the electronic device 700 including various units, it would be appreciated that not all of the units as shown are required to be implemented or provided. Alternatively, more or fewer units may be implemented or provided.

In particular, according to the embodiments of the present disclosure, the processes described above with reference to the flowcharts may be implemented as computer software programs. For example, embodiments of the present disclosure include a computer program product comprising computer programs carried on a computer readable medium, where the computer programs containing program code are used for performing the methods as in the flowcharts. In those embodiments, the computer programs may be downloaded and installed from a network via the communication apparatus 709, or may be installed from the storage apparatus 708, or may be installed from the ROM 702. The computer programs, when executed by the processing apparatus 701, perform the above-described functions defined in the method according to the embodiments of the present disclosure.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a Random-Only Memory (ROM), an Erasable Programmable Read-Only Memory (EPROM or flash memory), an optical fiber, a portable Compact Disc Read-Only Memory (CD-ROM), an optical storage apparatus, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

The computer-readable medium may be the one included in the electronic device, or may be provided separately, rather than assembled in the electronic device.

The computer-readable medium carries one or more programs which, when executed by the electronic device, cause the electronic device to implement the method according to the present disclosure, as described above.

Computer program code for performing operations of the present disclosure may be written by using one or more program design language or any combination. The programming language includes, but is not limited to, object oriented programming language such as Java, Smalltalk and C++, and further includes conventional procedural programming language such as “C” or similar programming language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a Local Area Network (LAN) and a Wide Area Network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by dedicated hardware-based systems which perform the specified functions or acts, or combinations of dedicated hardware and computer instructions.

Related units for describing the embodiments of the present disclosure may be implemented in the form of software, or may be implemented in the form of hardware. In certain circumstances, the names of units/modules do not formulate limitation to the units per se. For example, the first obtaining unit may also be described as “a unit configured to obtain at least two Internet Protocol (IP) addresses.”

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, a RAM, a ROM, an EPROM or flash memory, an optical fiber, a CD-ROM, an optical storage device, a magnetic storage device, or any suitable combination of the foregoing.

In a first aspect, according to one or more embodiments of the present disclosure, there is provided a rendering method, including:
obtaining a first context associated with a plurality of preset windows to be rendered, wherein the first context is used for managing a rendering resource and an interface status associated with each preset window;
performing, based on the first context, off-screen content rendering on an extended surface associated with each preset window, to obtain a rendered content corresponding to each preset window; and
rendering, based on a second context associated with each preset window, the rendered content corresponding to the preset window onto the preset window, wherein the second context is used for managing the extended surface corresponding to each preset window, and the first context shares a rendering resource with the second context associated with the preset window.

According to one or more embodiments of the present disclosure, performing, based on the first context, the off-screen content rendering on the extended surface associated with each preset window, to obtain the rendered content corresponding to each preset window, includes:
creating, for each preset window, an extended surface associated with the preset window; and
performing an off-screen rendering operation on the extended surface, based on the rendering resource and the interface status managed by the first context, to obtain the rendered content.

According to one or more embodiments of the present disclosure, obtaining the first context associated with the plurality of preset windows to be rendered includes:
in response to a trigger operation for a target application, determining a plurality of preset windows associated with the target application, wherein the rendering resource and the preset window have a preset mapping relationship therebetween;
determining a rendering resource and an interface status for rendering each preset window; and
generating the first context, based on the rendering resource and the interface status associated with each preset window.

According to one or more embodiments of the present disclosure, generating the first context, based on the rendering resource and the interface status associated with each preset window, includes:
setting, based on a preset condition, rendering sequence numbers for the rendering resources associated with the plurality of preset windows, wherein different rendering resources have different rendering sequence numbers.

According to one or more embodiments of the present disclosure, performing, based on the first context, the off-screen content rendering on the extended surface associated with each preset window, to obtain the rendered content corresponding to each preset window, includes:
performing sequentially, based on the rendering resource, an off-screen content rendering operation on the extended surface associated with each preset window, according to the rendering sequence number, to obtain the rendered content corresponding to each preset window.

According to one or more embodiments of the present disclosure, after performing, based on the first context, the off-screen content rendering on the extended surface associated with each preset window, to obtain the rendered content corresponding to each preset window, the method further includes:
storing, for each preset window, the rendered content corresponding to the preset window to a storage path associated with the preset window;
rendering, based on the second context associated with each preset window, the rendered content corresponding to the preset window to the preset window, including:
   obtaining, for each preset window, the rendered content corresponding to the preset window from the storage path associated with the preset window; and
   rendering, based on the second context associated with the preset window, the rendered content to the preset window.

According to one or more embodiments of the present disclosure, rendering, based on the second context associated with each preset window, the rendered content corresponding to the preset window onto the preset window includes:
for each preset window, in response to the extended surface associated with the preset window having been rendered, rendering, based on the second context associated with each preset window, the rendered content corresponding to the preset window onto the preset window, to obtain a rendering result.

According to one or more embodiments of the present disclosure, a preset effect engine runs on the first context, and the method further includes:
controlling the effect engine to perform, based on the first context, a content rendering operation on the plurality of preset windows.

In a second aspect, according to one or more embodiments of the present disclosure, there is provided a rendering apparatus, including:
an obtaining module for obtaining a first context associated with a plurality of preset windows to be rendered, wherein the first context is used for managing a rendering resource and an interface status associated with each preset window;
a rendering module for performing, based on the first context, off-screen content rendering on an extended surface associated with each preset window, to obtain a rendered content corresponding to each preset window; and
a processing module for rendering, based on a second context associated with each preset window, the rendered content corresponding to the preset window onto the preset window, wherein the second context is used for managing the extended surface corresponding to each preset window, and the first context shares a rendering resource with the second context associated with the preset window.

According to one or more embodiments of the present disclosure, the rendering module is used for:
creating, for each preset window, an extended surface associated with the preset window; and
performing an off-screen rendering operation on the extended surface, based on the rendering resource and the interface status managed by the first context, to obtain the rendered content.

According to one or more embodiments of the present disclosure, the obtaining module is used for:
in response to a trigger operation for a target application, determining a plurality of preset windows associated with the target application, wherein the rendering resource and the preset window have a preset mapping relationship therebetween;
determining a rendering resource and an interface status for rendering each preset window; and
generating the first context, based on the rendering resource and the interface status associated with each preset window.

According to one or more embodiments of the present disclosure, the obtaining module is used for:
setting, based on a preset condition, rendering sequence numbers for the rendering resources associated with the plurality of preset windows, wherein different rendering resources have different rendering sequence numbers.

According to one or more embodiments of the present disclosure, the rendering module is used for:
performing sequentially, based on the rendering resource, an off-screen content rendering operation on the extended surface associated with each preset window, according to the rendering sequence number, to obtain the rendered content corresponding to each preset window.

According to one or more embodiments of the present disclosure, the apparatus further includes:
a storage module for storing, for each preset window, the rendered content corresponding to the preset window to a storage path associated with the preset window; wherein
the processing module is used for:
   obtaining, for each preset window, the rendered content corresponding to the preset window from the storage path associated with the preset window; and
   rendering, based on the second context associated with the preset window, the rendered content to the preset window.

According to one or more embodiments of the present disclosure, the processing module is used for:
for each preset window, in response to the extended surface associated with the preset window having been rendered, rendering, based on the second context associated with each preset window, the rendered content corresponding to the preset window onto the preset window, to obtain a rendering result.

According to one or more embodiments of the present disclosure, a preset effect engine runs on the first context, and the method further incudes:
controlling the effect engine to perform, based on the first context, a content rendering operation on the plurality of preset windows.

In a third aspect, according to one or more embodiments of the present disclosure, there is provided an electronic device, including: a processor and a memory, wherein:
the memory stores therein computer executable instructions; wherein
the computer executable instructions stored in the memory, when executed by the processor, cause the processor to perform the rendering method in the first aspect and various possible rendering methods designed according to the first aspect.

In a fourth aspect, according to one or more embodiments of the present disclosure, there is provided a computer readable storage medium, wherein the computer readable storage medium stores therein computer executable instructions that, when executed by a processor, implement the rendering method in the first aspect and various possible rendering methods designed according to the first aspect.

In a fifth aspect, according to one or more embodiments of the present disclosure, there is provided a computer program product including a computer program, wherein the computer program, when executed by a processor, implements the rendering method in the first aspect and various possible rendering methods designed according to the first aspect.

The description above only relates to preferred embodiments of the present disclosure and technical principles applied therein. It would be appreciated by those skilled in the art that the scope disclosed herein is not limited to the particular combination of features described above, but also encompasses other embodiments in which any combination of the features described above or their equivalents does not depart from the spirit of the disclosure. For example, the above features and (but not limited to) the features disclosed in this disclosure having similar functions are replaced with each other to form the technical solution.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

I/We claim:

1. A rendering method, comprising:
obtaining a first context associated with a plurality of preset windows to be rendered, wherein the first context is used for managing a rendering resource and an interface status associated with respective preset windows;
performing, based on the first context, off-screen content rendering on an extended surface associated with each preset window, to obtain a rendered content corresponding to each preset window; and
rendering, based on a second context associated with each preset window, the rendered content corresponding to the preset window onto the preset window, the second context being used for managing the extended surface corresponding to each preset window, and the first context sharing a rendering resource with the second context associated with the preset window.

2. The method of claim 1, wherein performing, based on the first context, the off-screen content rendering on the extended surface associated with each preset window, to obtain the rendered content corresponding to each preset window, comprises:
creating, for each preset window, the extended surface associated with the preset window; and
performing an off-screen rendering operation on the extended surface, based on the rendering resource and the interface status managed by the first context, to obtain the rendered content.

3. The method of claim 1, wherein obtaining the first context associated with the plurality of preset windows to be rendered comprises:
in response to a trigger operation for a target application, determining a plurality of preset windows associated with the target application, wherein the rendering resources and the preset windows have a preset mapping relationship therebetween;
determining a rendering resource and an interface status for rendering the respective preset windows; and
generating the first context, based on the rendering resource and the interface status associated with the respective preset windows.

4. The method of claim 3, wherein generating the first context, based on the rendering resource and the interface status associated with the respective preset windows, comprises:
setting, based on a preset condition, rendering sequence numbers for the rendering resources associated with the plurality of preset windows, wherein different rendering resources have different rendering sequence numbers.

5. The method of claim 4, wherein performing, based on the first context, the off-screen content rendering on the extended surface associated with each preset window, to obtain the rendered content corresponding to each preset window, comprises:
performing sequentially, according to the rendering sequence numbers and based on the rendering resources, an operation of off-screen content rendering on the extended surface associated with each preset window, to obtain the rendered content corresponding to each preset window.

6. The method of claim 1, after performing, based on the first context, the off-screen content rendering on the extended surface associated with each preset window, to obtain the rendered content corresponding to each preset window, further comprising:
storing, for each preset window, the rendered content corresponding to the preset window to a storage path associated with the preset window;
wherein the rendering, based on the second context associated with each preset window, the rendered content corresponding to the preset window onto the preset window comprises:
obtaining, for each preset window, the rendered content corresponding to the preset window from the storage path associated with the preset window; and
rendering, based on the second context associated with the preset window, the rendered content onto the preset window.

7. The method of any of claims 1, wherein rendering, based on the second context associated with each preset window, the rendered content corresponding to the preset window onto the preset window comprises:
for each preset window, in response to the extended surface associated with the preset window having been rendered, rendering, based on the second context associated with the preset window, the rendered content corresponding to the preset window onto the preset window, to obtain a rendering result.

8. The method of any of claims 1, wherein a preset effect engine runs on the first context, and the method further comprises:
controlling the effect engine to perform, based on the first context, a content rendering operation on the plurality of preset windows.

9. An electronic device, comprising: a processor and a memory, wherein:
the memory stores therein computer executable instructions;
the computer executable instructions stored in the memory, when executed by the processor, cause the processor to:
obtain a first context associated with a plurality of preset windows to be rendered, wherein the first context is used for managing a rendering resource and an interface status associated with respective preset windows;
perform, based on the first context, off-screen content rendering on an extended surface associated with each preset window, to obtain a rendered content corresponding to each preset window; and
render, based on a second context associated with each preset window, the rendered content corresponding to the preset window onto the preset window, the second context being used for managing the extended surface corresponding to each preset window, and the first context sharing a rendering resource with the second context associated with the preset window.

10. The electronic device according to claim 9, wherein the computer executable instructions to perform, based on the first context, the off-screen content rendering on the extended surface associated with each preset window, to obtain the rendered content corresponding to each preset window, comprise instructions to:
create, for each preset window, the extended surface associated with the preset window; and
perform an off-screen rendering operation on the extended surface, based on the rendering resource and the interface status managed by the first context, to obtain the rendered content.

11. The electronic device according to claim 9, wherein the computer executable instructions to obtain the first context associated with the plurality of preset windows to be rendered comprise instructions to:
in response to a trigger operation for a target application, determine a plurality of preset windows associated with the target application, wherein the rendering resources and the preset windows have a preset mapping relationship therebetween;
determine a rendering resource and an interface status for rendering the respective preset windows; and
generate the first context, based on the rendering resource and the interface status associated with the respective preset windows.

12. The electronic device according to claim 11, wherein the computer executable instructions to generate the first context, based on the rendering resource and the interface status associated with the respective preset windows, comprise instructions to:
set, based on a preset condition, rendering sequence numbers for the rendering resources associated with the plurality of preset windows, wherein different rendering resources have different rendering sequence numbers.

13. The electronic device according to claim 12, wherein the computer executable instructions to perform, based on the first context, the off-screen content rendering on the extended surface associated with each preset window, to obtain the rendered content corresponding to each preset window, comprise instructions to:
perform sequentially, according to the rendering sequence numbers and based on the rendering resources, an operation of off-screen content rendering on the extended surface associated with each preset window, to obtain the rendered content corresponding to each preset window.

14. The electronic device according to claim 9, wherein after the computer executable instructions to perform, based on the first context, the off-screen content rendering on the extended surface associated with each preset window, to obtain the rendered content corresponding to each preset window, the instructions further cause the device to:
store, for each preset window, the rendered content corresponding to the preset window to a storage path associated with the preset window;
wherein the instructions to render, based on the second context associated with each preset window, the rendered content corresponding to the preset window onto the preset window comprise instructions to:
obtain, for each preset window, the rendered content corresponding to the preset window from the storage path associated with the preset window; and
render, based on the second context associated with the preset window, the rendered content onto the preset window.

15. The electronic device according to claim 9, wherein the computer executable instructions to render, based on the second context associated with each preset window, the rendered content corresponding to the preset window onto the preset window comprise instructions to:
for each preset window, in response to the extended surface associated with the preset window having been rendered, render, based on the second context associated with the preset window, the rendered content corresponding to the preset window onto the preset window, to obtain a rendering result.

16. The electronic device according to claim 9, wherein a preset effect engine runs on the first context, and the computer executable instructions further cause the device to:
control the effect engine to perform, based on the first context, a content rendering operation on the plurality of preset windows.

17. A non-transitory computer readable storage medium, wherein the computer readable storage medium stores therein computer executable instructions that, when executed by a processor, cause a computer to:
obtain a first context associated with a plurality of preset windows to be rendered, wherein the first context is used for managing a rendering resource and an interface status associated with respective preset windows;
perform, based on the first context, off-screen content rendering on an extended surface associated with each preset window, to obtain a rendered content corresponding to each preset window; and
render, based on a second context associated with each preset window, the rendered content corresponding to the preset window onto the preset window, the second context being used for managing the extended surface corresponding to each preset window, and the first context sharing a rendering resource with the second context associated with the preset window.

18. The non-transitory computer readable storage medium according to claim 17, wherein the computer executable instructions to perform, based on the first context, the off-screen content rendering on the extended surface associated with each preset window, to obtain the rendered content corresponding to each preset window, comprise instructions to:
create, for each preset window, the extended surface associated with the preset window; and
perform an off-screen rendering operation on the extended surface, based on the rendering resource and the interface status managed by the first context, to obtain the rendered content.

19. The non-transitory computer readable storage medium according to claim 17, wherein the computer executable instructions to obtain the first context associated with the plurality of preset windows to be rendered comprise instructions to:
in response to a trigger operation for a target application, determine a plurality of preset windows associated with the target application, wherein the rendering resources and the preset windows have a preset mapping relationship therebetween;
determine a rendering resource and an interface status for rendering the respective preset windows; and
generate the first context, based on the rendering resource and the interface status associated with the respective preset windows.

20. The non-transitory computer readable storage medium according to claim 19, wherein the computer executable instructions to generate the first context, based on the rendering resource and the interface status associated with the respective preset windows, comprise instructions to:
set, based on a preset condition, rendering sequence numbers for the rendering resources associated with the plurality of preset windows, wherein different rendering resources have different rendering sequence numbers.
